(19) United States
(12) Patent Application Publication
(10) Pub. No.: US 2009/0214790 A1
(43) Pub. Date: Aug. 27, 2009

(54) METHOD OF MAKING AN INK-PRINTED FIBROUS WEB

(76) Inventors: Stephen SIMPSON, Jersey City, NJ (US); Richard Czarnecki, Wayne, NJ (US); George Varughese, Orangeburg, NY (US)

Correspondence Address: PATENT DOCKET CLERK;COWAN, LIEBOWITZ & LATMAN, P.C., 1133 AVENUE OF THE AMERICAS, NEW YORK, NY, 10036, US

(21) Appl. No.: 12/391,432

(22) Filed: Feb. 24, 2009

Related U.S. Application Data
(60) Provisional application No. 61/031,129, filed on Feb. 25, 2008.

(51) Int. Cl. B05D 5/00

(52) U.S. Cl. 427/288

(57) ABSTRACT

A method of making an ink-printed fibrous web by applying onto at least one side of a coated fibrous web at least one ink layer of a planographic ink to form an image thereon to produce a printed fibrous web. The ink layer(s) has a total volatile content, as supplied, of less than 10% (preferably less than 5%). The printed fibrous web is then subjected to ambient temperatures without the use of a drying oven or by employing oven temperatures that have an exit web temperature that does not exceed 225° F. Subsequent processing of the printed fibrous web includes applying one or more coatings including a waterbased coating, a coating having a total volatile content of less than 10%, a coating that is cured with actinic radiation, and an anti-offset coating.

### REFERENCE TO RELATED APPLICATION

This application claims priority to U.S. provisional application No. 61/031,129, filed Feb. 25, 2008, the disclosure of which is incorporated herein by reference.

### FIELD OF THE INVENTION

The present invention is directed to the planographic printing of fibrous webs and the webs printed thereby. Specifically, the printed fibrous webs are coated paper webs printed with ink containing a low amount of total volatiles.

### BACKGROUND OF THE INVENTION

Printed matter can be generated by a number of processes and technologies, including flexographic, rotogravure, planographic, and non-impact printing. Planographic printing processes include conventional lithographic printing and waterless lithographic printing. Conventional lithographic printing is a process that utilizes a coated metal or polymeric plate containing a hydrophobic image area which accepts, i.e., it is wetted by, hydrophobic based ink and a non-image hydrophilic area which accepts water, i.e., the fountain solution. As practiced in the prior art, high speed web presses use inks that contain organic solvents to transport the ink. The drying of the printed ink film is achieved by solvent volatilization at a substrate temperature of about 250-400° F. and, to some degree, by penetration of the ink oil into the paper, leaving behind a hard polymeric film. Consequently, the use of such inks in the prior art requires highly sophisticated emission control equipment in order to comply with clean air and occupational standards for exposure to organic solvents. Considering these environmental standards and the costs associated with complying with them under practical industrial conditions, artisans in the field of ink development have been vigorously engaged in the development of new inks that will more readily meet environmental standards but still provide the quality performance demanded for the final printed product.

In waterless lithographic printing processes, the nonimage areas of the printing plate are coated with a polymer that repels the printing ink. The image areas are coated, for example, with a photosensitive polymer. Such printing processes are known, for example, from U.S. Pat. No. 5,370,906 and U.S. Pat. No. 5,417,749.

A typical heat setting web offset ink will contain the following major components: (a) a high molecular weight ink resin to disperse the pigment and also to provide the toughness and gloss the ink requires on drying; (b) solvents to provide the fluidity to the ink before it is placed on the web and dried in an oven; (c) pigment; and (d) other minor components such as gellants, which provide structure to the ink, plasticizers (non volatile solvents), waxes, thickeners, and antioxidants.

Heatset inks can be printed on both uncoated paper and coated paper. Coated paper is made from an uncoated fibrous web that has been modified by a process that applies chemicals, pigments, binders, and/or other substances to the fibrous surface(s) to supplement the sizings and fillers from earlier in the papermaking process.

A problem with such printed matter is that conventional heatset lithographic inks contain high levels of volatile organic compounds (VOC). Historically, lithographic web offset heatset inks contain between 30% and 45% VOC. Besides being detrimental to the environment, VOC's are also flammable and hazardous to the printers who operate the press. Thus, it is desirable to reduce the VOC content in lithographic web offset heatset inks as much as possible.

The content of volatile organic compounds (VOC) in a lithographic ink is typically determined by EPA Method 24. A 0.3-0.5 gram sample of ink is heated to 110° C. for one hour and the weight loss (total volatiles), corrected for water content and exempt compounds, is used to determine VOC content. For inks that do not contain water or exempt compounds, the total volatiles is equivalent to the total VOC content. It is known in the art that there are lithographic inks that intentionally contain water, exempt compounds, or a combination of water and exempt compounds.

Another problem with this earlier printed matter is that high temperatures (typically in the range of 250-400° F.) are required to set or dry the ink. This requires the use of large, expensive drying ovens that consume significant amounts of energy to achieve the high temperatures.

Sheetfed offset inks dry at room temperature by a combination of penetration and oxidation. Initial penetration of the ink oil into the paper or paper coating occurs very rapidly and it changes the ink composition sufficiently to induce precipitation of the polymer or resin-rich phase on the paper surface. Oxidation of the drying oils and/or resins also begins so that the ink film is sufficiently rigid to withstand limited mechanical forces and enables the job to be printed on the second side of the sheet very soon after completing the first side. Subsequently, further oxidation of the drying oils and/or resins further increases the rigidity of the ink film sufficiently to withstand rubbing and abrasion.

A typical sheetfed offset ink will contain the following major components: (a) a combination of resins such as a phenolic modified rosin ester and alkyds to disperse the pigment and also to provide the toughness and gloss the ink requires on drying; (b) oxidatively drying oils such as linseed oil; (c) high boiling paraffinic/naphthenic oils; (d) pigment, and (e) other minor components such as plasticizers (non volatile solvents), waxes, thickeners, and antioxidants. These inks contain some level of volatile content as a result of the high boiling paraffinic/naphthenic oil content. An alternative sheetfed offset ink can be formulated without the use of volatile high boiling paraffinic/naphthenic oils, achieving a total volatile content of less than 10%.

A problem with such printed matter is that these conventional sheetfed lithographic inks require, on average, over 30 minutes before the printed sheet is sufficiently dried and set so that it can be further processed. If these conventional inks were to be printed on a continuous web of coated paper, the printed ink surface would be marred by contact with printing and finishing machinery, damaging the printed image and rendering the product unusable. As a result, typical sheetfed web offset inks cannot be used to print on a continuous web of coated paper.

Coldset (nonheatset) web offset inks, or news inks are used to lithographically print on newsprint or absorptive (uncoated) stock. A typical coldest web offset (news) ink will contain the following major components: (a) a combination of vegetable and/or petroleum-derived oils; (b) pigment; and (c) other minor components such as waxes and resins. Coldset (nonheatset) web offset inks (news inks) typically achieve a total volatile content of less than 10%. These inks do not “dry” in the conventional sense in which resins undergo oxidative reactions to form a polymeric film. When the paper is printed, it is compressed in the nip formed between the blanket and impression cylinder, and the printing ink is forced into the surface elements of the paper. As the paper leaves the printing nip, the paper expands and the ink oil migrates to adjacent paper fibers. The relative rough surface of the uncoated paper helps protect the pigments from rubbing off. Coldset web offset inks (news inks) cannot be used to print coated paper. Modifying the press to print heatset inks would require significant additional equipment to be added, particularly ovens and solvent reclaim or incineration equipment. This would add expense and require additional space.

Heatset and coldest printing equipment will commonly utilize an applicator unit to apply anti-offset materials to the printed web. These materials, typically silicone blends, prevent the ink from smearing and marking that may occur from ink rub-off on idler rollers and the former board.

An existing solution is to use lithographic inks that have been modified with ethenylically unsaturated compounds which, when irradiated with ultraviolet or electron beam radiation, photopolymerize and form a crosslinked network. U.S. Pat. Nos. 6,451,873 and 6,489,375 describe low VOC cationic curable lithographic inks compatible with cationic catalysts containing monomeric diluents curable by cationic polymerization in the presence of fountain solution. While these inks are low in VOC content, they cannot be air dried using conventional printing machinery, but instead require the added expenses of higher cost raw materials and UV or electron beam curing equipment to photopolymerize the printed ink.

U.S. Pat. No. 5,431,721 describes lithographic ink resins and varnishes that employ non-volatile solvents. No examples of printing on a coated paper web are provided.

U.S. Pat. No. 7,018,453 describes low VOC web offset heatset inks containing less than about 2 wt % of VOC containing an aqueous polymer latex dispersed in an ink base of a resin, a non-volatile plasticizer, and a pigment and method for preparing same. While these inks are low in VOC content, they contain a significant amount of water as a volatile, which must be removed from the printed web in the drying step. These inks contain greater than 10% total volatiles (primarily water) and require a web exit temperature of 300° F.

U.S. Pat. No. 5,417,749 describes a printing ink useful for “waterless” printing processes comprising a water-in-oil microemulsion wherein the water phase is present in an amount of about 5 to 20 wt. %, based on the weight of the ink. The water phase contains about 0.5 to 3 wt. %, based on the weight of the ink, of a surfactant that will not lower the surface tension (as measured at ambient temperature) of the ink, but will preferably increase the surface tension of the ink by at least about 5%. The ink optionally contains about 0.05 to 0.5 wt. %, based on the weight of the ink, of a water-soluble polymer capable of producing a viscosity in the water phase of about 5 to 10 poise as measured at ambient temperature. While these inks are low in VOC content, they contain a significant amount of water as a volatile, which must be removed from the printed web in the drying step. No examples of printing on a coated paper web are provided.

U.S. Pat. No. 6,200,372 describes a single fluid water-based offset lithographic news ink comprising water; a macromolecular resin binder comprised of a resin soluble in water regardless of the pH of the water, a rosin salt resin soluble in water at pH ranging from 7.5 to 10 and an aqueous emulsion polymer; pigment; a water dispersible soy bean based polymer; and a hydroxyethylethylene urea re-wetting agent. While these inks are low in VOC content, they contain a significant amount of water as a volatile, which must be removed from the printed web in the drying step. No examples of printing on a coated paper web are provided.

U.S. Pat. No. 6,709,503 describes a waterbased heatset offset lithographic ink comprising water, polyamide resins or fumarated rosin resins, hydroxyethylethylene urea, a modified linseed oil, a dibutylated benzoguanamine, a pigment and p-toluene sulfonic acid. While these inks are low in VOC content, they contain a significant amount of water as a volatile, which must be removed from the printed web in the drying step. These inks require web exit temperatures of at least 265° C.

Other patent literature in the field includes Japanese Patent Publication JP 2001026735, Japanese Patent Publication JP 3247677, U.S. Pat. No. 5,158,606, and Japanese Patent Publication JP 5287228.

Patent Publication No. WO 2005113694 describes an emulsion composition that comprises water, a hydrocarbon distillate having a boiling point of 215 to 325° C., and a surfactant having a hydrophilic lipophilic balance number of 10 or less. A vehicle composition, an ink composition, a lithographic printing process and a method to improve a lithographic printing process comprise the emulsion composition which when used in a lithographic printing ink can reduce emission of volatile organic compounds and reduce the time at start-up to establish print quality. While these inks are low in VOC content, they contain a significant amount of water as a volatile, which must be removed from the printed web in the drying step. In addition, no claims are made about drying performance or improvements therein.

U.S. Pat. No. 5,552,467 describes rapidly heat curable lithographic ink systems containing catalytic redox means and cross-linking agents for the combined initiation of free radical polymerization and crosslinking of vegetable oil based printing inks containing unsaturated polyester resin(s) having available carboxylic acid groups. While these inks are low in VOC and contain little to no volatile compounds, they require drying and curing at temperatures above 212° F. (100° C.). Moreover, U.S. Pat. No. 5,552,467 teaches the usage of thermally activated combinations of chemical reducing agents, and organic (hydro) peroxides, one placed in the ink and the other contained in fountain solution as a means of overcoming the oxidative-polymerization drying component rate limitations of heat set lithographic inks. The patent discloses the use of two-part systems that inherently exclude usage in single fluid inks, and is limited further by the reactivity of the components, resulting in relatively short shelf life of solutions and/dispersions of many organic (hydro) peroxides, and of reducing agents in unsaturated oil based vehicles, especially those containing carbon black an/or heavy metal based pigments, and in gum containing fountain solution concentrates. The specified technology has not been claimed to be effective for use in systems that must dry at/or near ambient temperatures.

U.S. Pat. No. 5,173,113 describes an improved composition for use as a liquid vehicle in ink systems and for printing on diverse substrates. The functional constituents of the composition are unsaturated fatty acid esters, difunctional or multifunctional acrylate esters and optionally mixed esters of unsaturated fatty acid and difunctional or multifunctional acrylates and other alpha, beta unsaturated carboxylates. While these inks are low in VOC content, they are only suitable for uncoated stock in a coldset printing process, or, in a web offset heatset printing process, require drying temperatures of at least 340° F. Moreover, U.S. Pat. No. 5,173,113 teaches the utility of hydrogen peroxide as a fountain solution additive for the acceleration of drying of lithographic inks, by a factor of approximately twofold. This combination, however, is used as a two-part system, thus inherently precluding use in single fluid inks, and is also limited by the severe instability of hydrogen peroxide in the presence of many variable valence metals.

U.S. Pat. No. 5,156,674 teaches the utility of combinations of sodium perborate (which rapidly hydrolyzes on contact with water to produce hydrogen peroxide) and zirconium salts as lithographic fountain solution drying accelerators.

U.S. Patent Publication Nos. 2004/0143031, 2004/0154494, 2004/0211333, 2006/0201388, and 2006/0243160, and U.S. Pat. No. 7,157,505 describe rapidly drying, low volatile organic compound (VOC), minimal dot gain coatings, (including lithographic ink and varnish systems) based on combinations of multifunctional 2,5-bis (preferably unsaturated) fatty acid esters of 1,4-bis oxa-2,5-cyclohexadiene-2,5-diols, (meth)acrylates, allyl and/or vinyl ethers in lithographic inks and varnishes (2 to about 30 weight percent), including into otherwise conventional lithographic inks, and related vehicles and varnishes. While these inks are low in VOC content, they are only exemplified with printing of coated fibrous sheets. No examples are given for printing of coated fibrous webs.

In summary, problems with prior art printing include high volatile organic compounds, high energy consumption to dry and set the ink, and the need for expensive UV or electron beam equipment to photopolymerize an energy curable printing ink.

Thus, there is still a need for the lithographic printing of coated fibrous webs which provide a combined environmental benefit of low volatile organic compounds (VOC) and which require much lower energy to set and dry the printed web prior to processing.

### SUMMARY OF THE INVENTION

In accordance with the present invention, a method of making an ink-printed fibrous web is provided by applying onto at least one side of a fibrous web at least one ink layer of a planoographic ink to form an image thereon to produce a printed fibrous web, the ink layer(s) having a total volatile content, as supplied, of less than 10% (preferably less than 5%); and subjecting the printed fibrous web to ambient temperatures without use of a drying oven or oven temperatures having an exit web temperature not exceeding 225° F.

As an aspect of the present invention, the fibrous web is coated paper.

As a further aspect of the present invention, the applying step employs planographic printing to produce the printed fibrous web.

As a feature of this aspect, planographic printing is carried out utilizing conventional lithographic printing plates.

As another aspect of the present invention, the applying step utilizes a fountain solution.

As another aspect of the present invention, planographic printing is carried out utilizing waterless lithographic printing plates without the need for fountain solution.

As a further aspect of the present invention, the subjecting step is carried out without utilizing externally applied heat, actinic radiation or other source of energy after the ink is applied to the fibrous web.

As an additional aspect of the present invention, the ink layer applied to the fibrous web is not cured by exposure to actinic radiation.

As yet another aspect of the present invention, inks of different colors are applied to the fibrous web.

As yet a further aspect of the present invention, a waterbased coating layer is applied over the ink layer, and the applied waterbased coating layer is dried at a temperature not exceeding 225° F.

As yet an additional aspect of the present invention, a coating having less than 10% (preferably less than 5%) total volatiles is applied over the ink layer; and is dried at a temperature not exceeding 225° F.

As a further aspect of the present invention, a conventional heatset coating is applied over the ink layer; which is dried at a temperature above 225° F.

As another aspect of the present invention, an energy curable coating is applied over the ink layer; and actinic radiation is applied to cure the energy curable coating.

As an additional aspect of the present invention, an anti-offset material is applied over the ink layer.

As yet a further aspect of the present invention, the printed fibrous web is subsequently processed without marking or damaging it.

As a feature of this aspect, the subsequent processing includes rewinding, sheeting and/or folding the printed fibrous web.

According to various embodiments of the present invention, a method of planographic printing of multiple superimposed ink layers on a coated fibrous web with drying temperatures of no greater than 225° F. are provided to dry and set the ink prior to subsequent processing steps.

In one form of the invention, the method of printing comprises, preferably in the following order: (a) applying onto one or both sides of a coated fibrous web at least one ink layer of a planographic ink having a total volatile content, as supplied, of less than 10% (preferably less than 5%), (b) subjecting the printed fibrous web to (1) ambient temperature without the use of a drying oven, or (2) oven temperatures whereby the exit web temperature does not exceed 225° F.; (c) optionally treating the printed web by applying an anti-offset material at any point after (a); (d) processing (e.g., rewinding, sheeting, folding) the printed fibrous web without damaging the printed image thereon.

In another form of the invention, the method of printing comprises, in the following order: (a) applying onto one or both sides of a coated fibrous web at least one ink layer of a planographic ink having a total volatile content, as supplied, of less than 10% (preferably less than 5%), (b) overprinting the web with a heatset lacquer; (c) subjecting the printed fibrous web to oven temperatures whereby the exit web temperature exceeds 225° F.; (c) optionally treating the printed web by applying an anti-offset material; (d) processing (e.g., rewinding, sheeting, folding) the printed fibrous web without damaging the printed image thereon.

In a further form of the invention, the method of printing comprises, in the following order: (a) applying onto one or both sides of a coated fibrous web at least one ink layer of a planographic ink having a total volatile content, as supplied, of less than 10% (preferably less than 5%), (b) subjecting the printed fibrous web to (1) ambient temperature without the use of a drying oven, or (2) oven temperatures whereby the exit web temperature does not exceed 225° F.; (c) applying onto one or both sides of the printed web a layer of a waterbased coating; (d) subjecting the printed, coated fibrous web to (1) ambient temperature without the use of a drying oven, or (2) oven temperatures whereby the exit web temperature does not exceed 225° F.; (e) optionally treating the printed web by applying an anti-offset material at any point after (a); (f) processing (e.g., rewinding, sheeting, folding) the printed fibrous web without damaging the printed image thereon.

In yet another form of the invention, the method of printing comprises, in the following order: (a) applying onto one or both sides of a coated fibrous web at least one ink layer of a planographic ink having a total volatile content, as supplied, of less than 10% (preferably less than 5%), (b) subjecting the printed fibrous web to (1) ambient temperature without the use of a drying oven, or (2) oven temperatures whereby the exit web temperature does not exceed 225° F.; (c) applying onto one or both sides of the printed web a layer of a coating having a total volatile content, as supplied, of less than 10% (preferably less than 5%); (d) subjecting the printed, coated fibrous web to (1) ambient temperature without the use of a drying oven, or (2) oven temperatures whereby the exit web temperature does not exceed 225° F.; (e) optionally treating the printed web by applying an anti-offset material at any point after (a); (f) processing (e.g., rewinding, sheeting, folding) the printed fibrous web without damaging the printed image thereon.

In an additional form of the invention, the method of printing comprises, in the following order: (a) applying onto one or both sides of a coated fibrous web at least one ink layer of a planographic ink having a total volatile content, as supplied, of less than 10% (preferably less than 5%), (b) subjecting the printed fibrous web to (1) ambient temperature without the use of a drying oven, or (2) oven temperatures whereby the exit web temperature does not exceed 225° F.; (c) applying onto one or both sides of the printed web a layer of coating which can be cured by actinic radiation; (d) curing the coating on the printed fibrous web by exposure to actinic radiation; (e) optionally treating the printed web by applying an anti-offset material at any point after (a); (f) processing (e.g., rewinding, sheeting, folding) the printed fibrous web without damaging the printed image thereon.

The invention also covers combinations of the above processing steps such as (but not limited to) a process that combines a lithographic overprint with a waterbased and/or UV/EB curable coating.

Other features, and objects and advantages of the present invention will become apparent from the following description and appended claims.

### DETAILED DESCRIPTION OF THE INVENTION

The present invention relates to a novel process for the printing of planographic inks on a continuous web printing press, wherein the inks are formulated to achieve a total volatile content of less than 10% (preferably less than 5%). Total volatile content, defined as the sum total of volatile organic compounds (VOC) plus any other volatile compound that is not deemed to be a VOC (such as, but not limited to, water) can be determined through the use of EPA Method 24. Lithographic inks that cure or crosslink by exposure to actinic radiation (typically ultraviolet or electron beam) are excluded from the invention.

According to the present invention, planographic ink is printed on a fibrous web comprising a cellulosic material. The term “cellulosic material” denotes paper or board or a corresponding cellulose-containing material, which is derived from a lignocellulosic raw material, in particular from wood or from annual or perennial plants. This material can be wood-containing or wood-free (LWC, SC, coated printing papers and fine papers) and it can be produced from mechanical, semi-mechanical (chemi-mechanical) or chemical pulp. The pulp can be bleached or unbleached. The material can also contain recycled fibers, in particular reclaimed paper or reclaimed board. Typically, the grammage of the material web lies in the range of 20 to 500 g/m2.

The fibrous cellulosic web is subsequently coated, which produces sharper, brighter images and better reflectivity than uncoated paper. Coated paper is modified by a process that applies chemicals, pigments, binders, and/or other substances to the fibrous surface(s) to supplement the sizings and fillers from earlier in the papermaking process. These surface modifying agents can include, for example, calcium carbonate, gypsum, aluminum silicate, kaolin, aluminum hydroxide, magnesium silicate, talc, titanium dioxide, barium sulfate, zinc oxide, synthetic pigment, or mixtures thereof.

In general, the grammage of base paper is 20-250 g/m2, preferably 30-80 g/m2. By coating a base paper of this type, having a grammage of approx. 50-70 g/m2, with 10-20 g of coating/m2/side and by calendering the paper, there is obtained a product having a grammage of 70-110 g/m2, whiteness of at least 90% and opacity of at least 90%. An especially preferred product is a coated offset paper in which high gloss and high opacity and bulk are combined. The invention is also suited for the production of coated fine papers, possibly also containing mechanical pulp, as well as writing and printing papers.

The method provided by the present invention is for the application of one or more layers of ink on a fibrous web. Once the ink has been deposited onto the web, the web can be optionally exposed to oven temperatures whereby the exit web temperature does not exceed 225° F. Following this step, the printed web can be processed by rewinding, sheeting, folding, etc., without damaging the printed image.

There is also the option, after the step of printing, to overprint the web with either a conventional heatset overprint varnish (OPV) or an overprint varnish containing less than 10% (preferably less than 5%) total volatiles. In the case of a conventional heatset OPV, the next processing step is to pass the web through an oven such that the exit web temperature is greater than 225° F. In the case of the overprint varnish containing less than 5% total volatiles, the next, optional processing step is oven drying such that the exit web temperature does not exceed 225° F.

There is also the option, after the step of printing, to coat the web with a waterbased coating, a coating containing less than 5% total volatiles, an “energy curable” coating, or any combination of these coatings and the aforementioned OPV's. In the case of the waterbased coating and the coating containing less than 10% (preferably less than 5%) total volatiles, the next processing step, optionally, is to oven dry the web such that the exit web temperature does not exceed 225° F. In the case of the “energy curable” coating, the web must be exposed to actinic radiation. The term “energy-curable”, as used herein, is intended to mean compositions that are polymerizable or crosslinkable by the action of a radiant energy source of actinic radiation, such as ultraviolet radiation (UV), electron beam radiation (EB), and the like. As used herein “actinic radiation” is intended to encompass radiation having a wavelength range from about 190 nm to about 400 nm, and preferably from about 240 nm to 400 nm. Actinic radiation of this type may be obtained from a variety of sources, e.g., mercury arc lamps, xenon arc lamps, fluorescent lamps, monochromatic laser sources, and the like. Actinic radiation as used herein also is intended to encompass high-energy electrons, such as from electric discharge devices or electron beam devices.

At any step in the process following the step of printing, there is the option of applying an anti-offset material to the web. These materials, typically silicone blends, prevent the ink from smearing and marking that may occur from ink rub-off on idler rollers and the former board.

Four experimental planographic inks (cyan, magenta, yellow, and black) were prepared from the components set forth in Table 1 below:

TABLE 1

| Component: | Weight % |
|---|---|
| Pigment | 15-20% |
| Resins, oils and other | 75-80% |
| nonvolatile components | |
| Volatile components | <5% |
| Total: | 100.0 |

### EXAMPLE 1

Process cyan, magenta, yellow and black inks from Table 1 were printed on both sides of 80 pound coated stock using a Heidelberg Sunday 2000 web press. The printed web was then lithographically overprinted with Superior Printing Ink W-6437, a conventional heatset overprint varnish. The web was then dried by passing through an oven having an exit web temperature of 260° F. The printed web was then treated with a silicone applicator. Finally, the printed web was processed through a combination folder, producing defect-free printed product.

### EXAMPLE 2

Process cyan, magenta, yellow and black inks from Table A were printed on both sides of 80 pound West Linn Paper Capistrano Web Gloss using a Heidelberg Sunday 2000 web press. The printed web was then coated with a Kelstar Aquatrain waterbased coating. The printed web was then passed through an oven having an exit web temperature of 128° F. The printed web was then treated with a silicone applicator. Finally, the printed web was processed through a combination folder, producing defect-free printed product.

The present invention has been described in the context of a number of embodiments and variations and examples thereof. It is to be understood, however, that other expedients known to those skilled in the art or disclosed herein may be employed without departing from the spirit of the invention. Therefore, it is intended that the appended claims be interpreted as including the embodiments described herein, the alternatives mentioned above, and all equivalents thereto.

1. A method of making an ink-printed fibrous web, comprising:
applying onto at least one side of a fibrous web at least one ink layer of a planographic ink to form an image thereon to produce a printed fibrous web, the at least one ink layer having a total volatile content, as supplied, of less than 10%; and
subjecting the printed fibrous web to one of ambient temperature without use of a drying oven and oven temperatures having an exit web temperature not exceeding 225° F.

2. The method of claim 1, wherein the fibrous web is coated paper.

3. The method of claim 1, wherein the at least one ink layer has a total volatile content, as supplied, of less than 5%.

4. The method of claim 1, wherein the applying step employs planographic printing to produce the printed fibrous web.

5. The method of claim 4, wherein planographic printing is carried out utilizing conventional printing plates and fountain solution.

6. The method of claim 4, wherein planographic printing is carried out utilizing waterless printing plates without the use of fountain solution.

7. The method of claim 1, wherein the subjecting step is carried out without utilizing externally applied heat, actinic radiation or other source of energy after ink is applied to the fibrous web.

8. The method of claim 1, wherein the ink layer applied to the fibrous web is not cured by exposure to actinic radiation.

9. The method of claim 1, wherein the applying step comprises applying onto the fibrous web inks of different colors.

10. The method of claim 1, further comprising applying a waterbased coating layer over the at least one ink layer; and drying the applied waterbased coating layer at a temperature not exceeding 225° F.

11. The method of claim 1, further comprising applying a coating having less than 10% total volatiles over the at least one ink layer; and drying the applied coating having less than 10% total volatiles at a temperature not exceeding 225° F.

12. The method of claim 1, further comprising applying a conventional heatset coating over the at least one ink layer; and drying the applied conventional heatset coating at a temperature above 225° F.

13. The method of claim 1, further comprising applying an energy curable coating over the at least one ink layer; and applying actinic radiation to cure the applied energy curable coating.

14. The method of claim 1, further comprising applying an anti-offset material over the at least one ink layer.

15. The method of claim 1, further comprising processing the printed fibrous web after the subjecting step without marking or damaging the printed fibrous web.

16. The method of claim 15, wherein the processing step is one of rewinding, sheeting and folding the printed fibrous web.
